(19) United States
(12) Patent Application Publication
(10) Pub. No.: US 2006/0207402 A1
(43) Pub. Date: Sep. 21, 2006

(54) SAW BLADE

(76) Inventors: Craig Peter Ernest Davidson, Cornelius, NC (US); Barry Walton, Mathesons Bay (NZ); Michael John Kelly, Warkworth (NZ)

Correspondence Address: MOORE & VAN ALLEN PLLC, P.O. BOX 13706, Research Triangle Park, NC, 27709, US

(21) Appl. No.: 10/906,380

(22) Filed: Mar. 17, 2005

(51) Int. Cl. B27B 33/02

(52) U.S. Cl. 83/836

(57) ABSTRACT

In one embodiment of the invention, the saw blade of the invention includes a plate supporting a plurality of teeth about the periphery thereof. Each tooth consists of a tooth support supporting a cutting tip. The tips are formed and arranged such that tips having a narrower profile are alternated with tips having a wider profile. In another embodiment of the invention teeth are provided where the distal ends of every other tip extend radially further from the center of the blade than the other tips. In another embodiment of the invention, a plurality of teeth consisting of a tooth support and tip are formed around the periphery of the plate such that teeth having a first hook angle alternate with teeth having a second hook angle. In a method of manufacturing the blade of the invention, identical tips are formed on all of the tooth supports and the ends of the tips are ground to the desired dimension after being formed on tooth supports.

### BACKGROUND OF THE INVENTION

The invention relates generally to saw blades and more particularly to a rotary saw blade having improved cutting characteristics.

Rotary saw blades typically consist of a plurality of teeth extending generally radially from the periphery of a round metal plate. An arbor hole is formed in the center of the plate to attach the blade to the arbor of a rotary tool such as a table saw, circular saw or the like such that the blade can be rotated by the rotary tool. Saw blades typically come with tooth counts that correspond to industry norms. For example blades having 18, 24, 40, 60 and 80 teeth are common and other tooth counts are also widely used. Blades are generally configured for specific types of cutting applications and for use with particular types of materials where the tooth count may be related to a specific intended use of the saw blade. Generally, assuming variables such as the material to be cut, blade speed, type of cut and the like remain constant, a saw blade with fewer teeth cuts faster than a similar saw blade with more teeth but the saw blade with more teeth makes a cleaner cut than the saw blade with fewer teeth. For example, a twelve tooth blade used with the same saw, on the same material and making the same type of cut will cut faster than a twenty-four tooth saw blade of the same type. The twenty-four tooth saw blade, however, will make a cleaner cut with smoother cut surfaces and edges. Thus, saw blades of a similar construction tend to trade speed for finish by using a fewer or greater number of teeth.

In order to improve saw blade performance saw blades having various teeth configurations have been developed. Typically, these blades utilize a combination of widely varying tooth configurations arranged about the periphery of the blade in relatively complex patterns. Because of the complexity of the tooth configurations and the arrangement of the teeth about the periphery of the blade, known blades tend to be difficult and/or expensive to manufacture.

Thus, a saw blade that is simple and inexpensive to manufacture and that obtains some of the speed of a lower count tooth blade with the finish performance of a higher count tooth blade is desired.

### SUMMARY OF THE INVENTION

In one embodiment of the invention, the saw blade of the invention includes a plate supporting a plurality of teeth about the periphery thereof. Each tooth consists of a tooth support supporting a cutting tip. The tips are formed and arranged such that tips having a narrower profile are alternated with tips having a wider profile. In one method of manufacturing the blade of the invention, identical tips supported on the tooth supports are ground to the desired width. Both sides of all of the tips are ground; however, the sides of the narrower profile teeth are ground more than the sides of the wider profile teeth to create the different tooth profiles.

In another embodiment of the invention the teeth may be provided where the distal ends of every other tip extend radially further from the center of the blade than the other tips. In a method of manufacturing the blade of the invention, identical tips are formed on all of the tooth supports and the ends of the tips are ground after being formed on tooth supports. While all of the tips are ground, every other tip is ground more than the adjacent tips to create the radial difference.

In another embodiment of the invention, a plurality of teeth consisting of a tooth support and tip are formed around the periphery of the plate such that teeth having a first hook angle alternate with teeth having a second hook angle. In a method of manufacturing the blade of the invention, identical tips are formed on the tooth supports and the differing hook angles are created by varying the grinding of the leading faces of the tips.

### BRIEF DESCRIPTION OF THE DRAWINGS

FIG. 1 is a side view of an embodiment of the saw blade of the invention.

FIG. 2 is a partial side view of the opposite side of the saw blade of FIG. 1.

FIG. 3 is a partial cut-away section view taken along line 3-3 of FIG. 2.

FIG. 4 is a block diagram of the method of making the saw blade of the invention.

FIG. 5 is a partial side view of another embodiment of the saw blade of the invention.

FIG. 6 is a partial side view of yet another embodiment of the saw blade of the invention.

FIG. 7 is a detailed side view of two tips of the saw blade of the invention.

FIG. 8 is a detailed top view of two tips of the saw blade of the invention.

### DETAILED DESCRIPTION OF VARIOUS EMBODIMENTS OF THE INVENTION

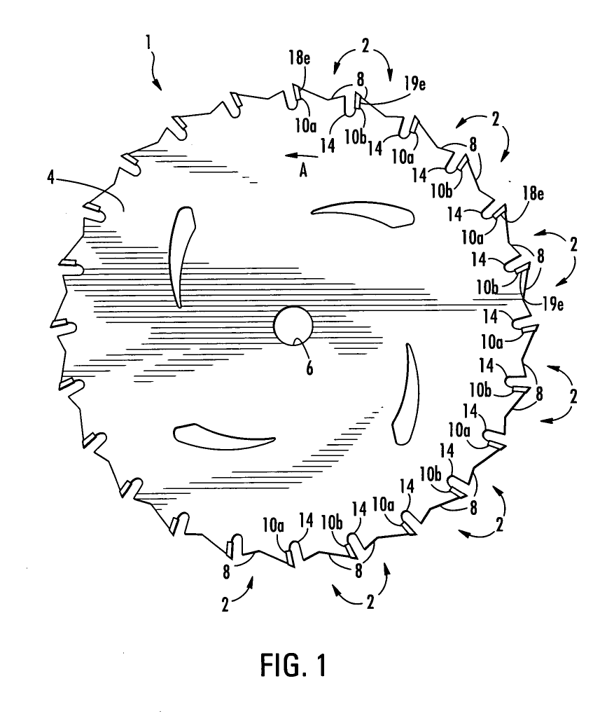

FIG. 1 shows a side view of one embodiment of the saw blade 1 of the invention. Blade 1 has twenty-four teeth 2 arranged about the periphery of plate 4. It is to be understood that the invention can be used with a saw blade having any number of teeth and that the twenty-four tooth blade is used by way of example only. A hole 6 is centrally located in plate 4 to attach the saw blade to the arbor of a rotary tool such as a circular saw, table saw, powered miter saw or the like in a known manner to rotate the blade in the direction of arrow A as is known in the art.

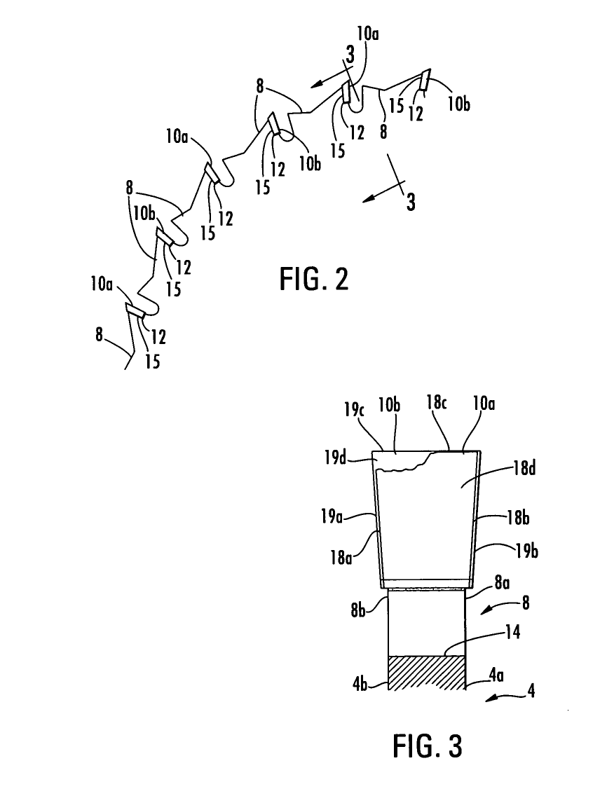

Referring to FIGS. 1 and 2, each tooth 2 consists of a tooth support 8 supporting either cutting tip 10a or cutting tip 10b. Tooth support 8 is preferably formed integrally with the plate 4, extends radially from the periphery of the plate and has the same thickness as the plate 4. A gullet 14 is formed between each of the teeth defining the areas between the teeth. In a preferred embodiment cutting tips 10a and 10b include a piece of material such as micro grain carbide brazed onto the tooth supports 8 at tip seats 12. Tips 10a and 10b typically would be made of a material having a high hardness and would ordinarily be of a harder and more expensive material than plate 4 and tooth supports 8.

Referring to FIGS. 2 and 3, tips 10a include opposed side faces 18a and 18b, top face 18c, leading face 18d and trailing face 18e (not in diagram). Tips 10b include opposed side faces 19a and 19b, top face 19c, leading face 19d and trailing face 19e (not in diagram). Seats 12 consist of portions of the tooth supports formed to receive the trailing faces 18e and 19e of the cutting tips. Each tip seat 12 supports one of either tip 10a or tip 10b and form the surface for providing the attachment such as by brazing. The tips 10a and 10b could be formed integrally with the plate 4 and tip supports 8.

As best shown in FIG. 3, tips 10a and 10b are wider than plate 4 such that side faces 18a, 18b and 19a, 19b are positioned beyond the side surfaces 4a and 4b of plate 4 and side surfaces 8a and 8b of tooth supports 8. The tips 10a and 10b extend beyond the sides of plate 4 forming the tooth set that creates the kerf. Tips 10a and 10b have the same overall shape and are formed on tooth supports 8 in the same manner except that tips 10a have a slightly narrower profile than tips 10b. More specifically, tips 10a have a smaller extent in the width dimension (the width being the dimension perpendicular to surfaces 4a and 4b) than tips 10b. The difference in width of tips 10a and 10b is exaggerated for illustrative purposes in FIG. 3. In practice the width of tips 10a is approximately 0.1 to 0.3 millimeters less than the width of tips 10b. The difference in width extends for the height of the tips.

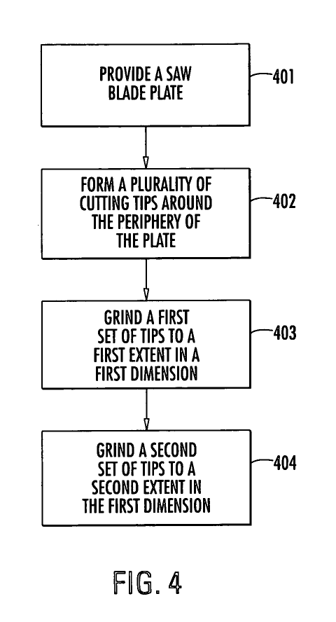

In the preferred method of manufacturing the blade of the invention a grinding operation is used to finish and size the tips 10a and 10b. Referring to FIG. 4, a plate 4 is provided (block 401). Cutting tips 10a and 10b are formed on the tooth supports 8 spaced about the periphery of plate 4 (block 402). In one embodiment the tips are brazed onto tooth supports and are comprised of a different material than the plate. The tips are ground after being formed on tooth supports 8. The first set of tips 10a are ground to a first extent in a desired dimension (block 403) and the second set of tips 10b are ground to a second extent in the desired dimension (block 404). In the embodiment of FIGS. 1 through 3 the dimension is the width of the tips. Both side faces 18a and 18b of tips 10a and side faces 19a and 19b of tips 10b are ground, however, the sides of tips 10a are ground more than the sides of tips 10b such that tips 10a have a narrower tooth profile as previously described with respect to FIG. 3. The first set of tips 10a could be ground simultaneously and then the second set of tips 10b ground simultaneously or the tips could be ground serially or all of the tips could be ground simultaneously. The tips are ground such that tips 10a alternate with tips 10b about the periphery of plate 4 as shown in FIGS. 1 and 2. Thus, every tooth has either a narrower profile than the two adjacent teeth or a wider profile than its two adjacent teeth and every other tooth has the same profile.

The tooth supports, tips prior to grinding, the tip seats and the gullet configurations are substantially identical for all of the teeth. Thus, the manufacture of the blade is greatly simplified as identical components are used for all teeth with the only difference being in the grinding of the side faces of teeth 10a and 10b. While a method of manufacturing the teeth by grinding both sides of the tips after the tips are attached to tooth supports 8 has been described, it is contemplated that the tips could be made of different widths such that each tooth may be ground the same amount such that the difference in widths is created by the pre-ground size of the tips. Alternatively the tips could be manufactured in different widths and not ground at all or only one side of the tips could be ground.

It is expected that for blades having tooth counts in the mid-range, i.e. 24 to 40 teeth, the blade of the invention having alternating narrow and wide teeth will cut 20% faster than a similar blade having the same tooth count but not using the tooth arrangement of the invention.

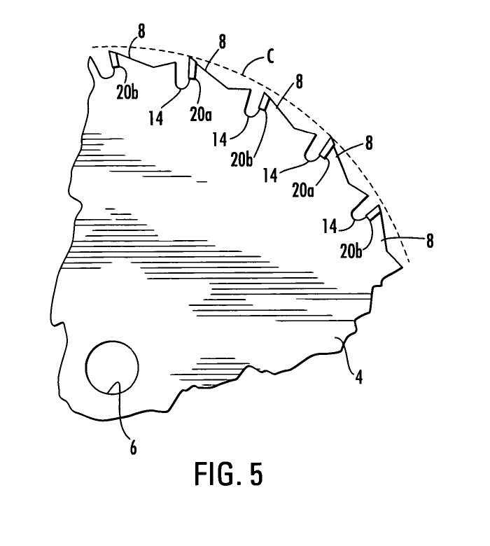

Referring to FIG. 5 a saw blade is shown having tips 20a and 20b. The same reference numerals are used in FIG. 5 to refer to the same elements previously described with reference to FIGS. 1 to 3. Some of the common reference numerals have been omitted from FIG. 5 for clarity of illustration. Tips 20a are made to extend radially farther from the center of the blade than tips 20b. To illustrate this arrangement, a dashed arc of a circle C is drawn in FIG. 5 connecting the distal ends of tips 20a. The distal ends of tips 20b do not extend to arc C. In one embodiment tips 20a extend beyond tips 20b approximately 0.22-0.25 millimeters.

In a method of manufacturing the blade of the invention, the ends of tips 20a and 20b are ground after being attached to tooth supports 8. Both tips 20a and 20b are ground, however, tips 20b are ground have a smaller extent in the radial dimension than the tips 20a to create the difference in radial extent described with respect to FIG. 5. Teeth with tips 20a alternate with teeth with tips 20b around the periphery of plate 4. Thus, every tooth has either a greater radial extent than its two adjacent teeth or a lesser radial extent than its two adjacent teeth and every other tooth is identical.

While a method of manufacturing the teeth by grinding the tips after the tips are on tooth supports has been described, it is contemplated that the tips could be made of different lengths where each tooth is ground the same amount such that the difference in tooth height is created by the pre-ground size of the tips. Alternatively the tips could be manufactured in different lengths and not ground at all. Moreover, the alternating tooth width arrangement described with reference to FIGS. 1-4 could be used in combination with the alternating radial extent described with reference to FIG. 5 such that in one embodiment teeth 20a in addition to extending radially outward further than tips 20b are also wider than tips 20b such that tips 20a will cut more material than teeth 20b and will begin to wear down first.

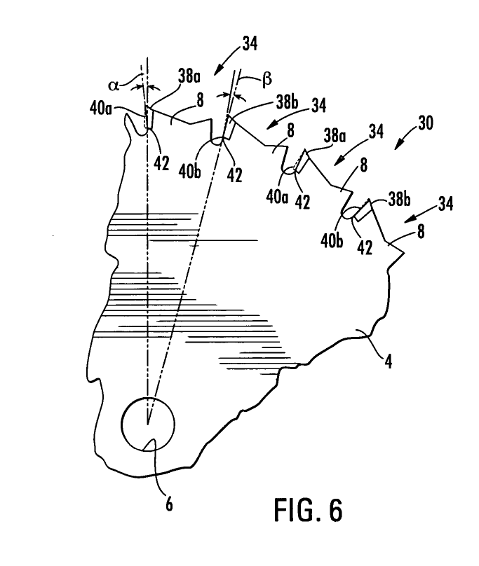

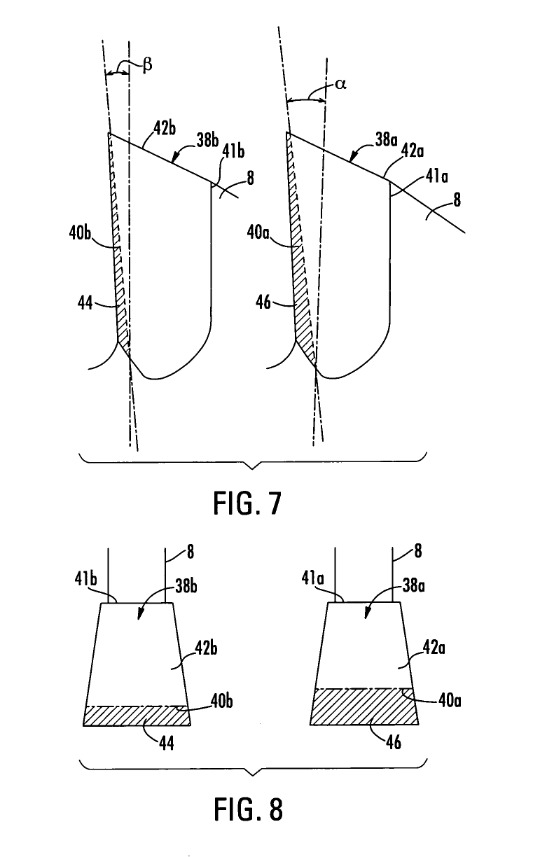

Another embodiment of the saw blade of the invention having improved cutting characteristics is shown in FIGS. 6. The same reference numerals are used in FIGS. 6 and 7 to refer to the same elements previously described with reference to FIGS. 1 to 3 with some of the reference numerals omitted in FIGS. 6 and 7 for clarity of illustration. A saw blade 30 is shown having a plate 4 with an arbor hole 6. About the periphery of plate 4 are teeth 34 consisting of tooth supports 8. Tips 38a and 38b are disposed in supports 8 such that tips 38a have a first hook angle α and alternating tips 38b have a second hook angle β. The hook angle is defined as the angle created between a line drawn from the center of the blade to the proximate edge of the leading face of the tip and the plane of the leading face. As best shown in FIG. 7, for teeth with tips 38a hook angle α is the angle formed by the leading face 40a and the line drawn from the center of the blade to the proximate edge of the leading face. Likewise, for teeth with tips 38b hook angle β is the angle formed by the leading face 40b and the line drawn from the center of the blade to the proximate edge of the leading face.

In a method of manufacturing the blade of the invention a grinding operation is used to create the hook angles of teeth having tips 38a and 38b. Specifically, tips 38a and 38b are ground after being attached to tooth supports 8. The leading faces 40a and 41a of tips 38a and tips 38b are ground, however, the leading faces of tips 38a are ground to a greater extent and at a greater angle than the faces of tips 38b such that teeth having tips 38a have a greater hook angle than teeth having tips 38b.

The grinding operation is represented in FIGS. 7 and 8 where the material removed from the tips during the grinding operation is represented by shaded areas 44 and 46, respectively. More material is removed from tips 38a and than tips 38b and more material is removed from the end of the tips proximate the tooth supports 8 than is removed from the ends of the tips distal to supports 8 such that the hook angle of the teeth is changed. In one embodiment teeth having tips 38a have a hook angle of 23 degrees while teeth having tips 38b have a hook angle of 20 degrees.

Referring to FIGS. 7 and 8, tips 38a and 38b decrease in width from the leading faces 40a, 40b to the trailing faces 41a, 41b, respectively. Moreover the top faces 42a and 42b decrease in height relative to the periphery of the blade from the leading face to the trailing face. Thus when the leading faces 40a, 40b of the tips 38a, 38b are ground, the material represented by shaded areas 44 and 46 are removed from tips 38a and 38b, respectively. Because more material is removed from tips 38a than tips 38b, teeth having tips 38a are actually narrower (see FIG. 8) and shorter (see FIG. 9) than teeth having tips 38b after the grinding operation is complete. Thus, in addition to manufacturing the hook angles, face grinding may be used to provide the alternating tooth thickness described with respect to FIGS. 1-4 and alternating radial differences described with respect to FIG. 5.

Teeth having tips 38a alternate with teeth having tips 38b about the periphery of plate 4. Thus, every tooth has either a greater hook angle than the two adjacent teeth or a lesser hook angle than its two adjacent teeth and every other tooth has the same hook angle. Because face grinding removes a different amount of material from teeth having tips 38a than teeth having tips 38b and the teeth alternate, the pitch between adjacent teeth will also alternate. Pitch is defined as the distance between the distal ends of leading faces 40a, 40b of adjacent teeth. At the distal end of tips 38a and 38b the difference in the amount of material removed will create a delta Δ in the thickness of the teeth where Δ is the difference between the thickness of the material 46 removed from tip 38a and the thickness of the material 44 removed from tip 38b. Thus, between a leading tooth 38a and a trailing tooth 38b the pitch is greater than the pitch between a leading tooth 38b and a trailing tooth 38a. Specifically, if d is the theoretical distance between the tips if no material is removed, the pitch between a leading tooth 38b and a trailing tooth 38a is distance d minus Δ and the pitch between a leading tooth 38a and a trailing tooth 38b is distance d plus Δ.

The teeth are mounted to the tooth supports in the same manner and use identical seat configurations. Thus, the manufacture of the blade is greatly simplified as identical components are used with the only change being in the grinding of the leading faces of tips 38a and 38b.

The alternating hook angle could also be created using identical tips where every other tip seat is set into tooth support at a different angle. Specifically, a first tip seat configuration is provided that is disposed to create the first hook angle and a second tip seat configuration is provided that creates the second hook angle. Alternatively all of the seats could have the same configuration and the difference in hook angles be created by using tips having different pre-ground face angles. A combination of seat configurations, tips and grinding could also be used to provide the desired alternating hook angles.

Specific embodiments of an invention are described herein. One of ordinary skill in the computing and networking arts will quickly recognize that the invention has other applications in other environments. In fact, may embodiments and implementations are possible. The following claims are in no way intended to limit the scope of the invention to the specific embodiments described above.

What is claimed is:

1. A saw blade comprising:
a plurality of teeth disposed about the periphery of the blade, each of said plurality of teeth including a tooth support and a cutting tip where the cutting tip is wider than the tooth support;
said plurality of teeth including a first set of teeth where the cutting tips have a first profile and a second set of teeth where the cutting tips have a second profile.

2. The saw blade of claim 1, wherein the teeth of the first set of teeth alternate with the teeth of the second set of teeth.

3. The saw blade of claim 1, wherein the cutting tips are formed of a first material and said tooth supports are formed of a second material.

4. The saw blade of claim 1, wherein the first profile has a narrower width than the second profile.

5. The saw blade of claim 1, wherein the first profile extends radially further from the center of the blade than the second profile.

6. The saw blade of claim 3, wherein the cutting tips are brazed on the tooth supports.

7. The saw blade of claim 1, wherein the plurality of teeth are formed on a plate, said plate defining a hole.

8. The saw blade of claim 1, wherein the first set of teeth and the second set of teeth extend around the entire periphery of the blade.

9. A saw blade comprising:
a plurality of teeth disposed about the periphery of the blade, each of said plurality of teeth including a tooth support and a cutting tip;
said plurality of teeth including a first set of teeth having a first hook angle and a second set of teeth having a second hook angle.

10. The saw blade of claim 9, wherein the teeth of the first set of teeth alternate with the teeth of the second set of teeth.

11. The saw blade of claim 9, wherein the cutting tips are formed of a first material and said tooth supports are formed of a second material.

12. A method of making a saw blade comprising:
forming a plurality of tooth supports about the periphery of the blade;
supporting a plurality of cutting tips on the plurality of tooth supports, one of said tooth supports supporting one of said plurality of cutting tips;
grinding selected ones of the plurality of cutting tips such that said selected ones of the cutting tips have a different extent in a dimension than other ones of the plurality of cutting tips;
alternating the selected ones of the cutting tips with the other ones of the plurality of cutting strips.

13. The method of claim 12 comprising:
grinding a side face of the cutting tips.

14. The method of claim 12 comprising:
grinding a top face of the cutting tips.

15. The method of claim 12 comprising:
grinding a leading face of the cutting tips.

16. A saw blade comprising:
a plurality of tooth supports formed of a first material disposed about the periphery of the blade;
a plurality of cutting tips, one of said plurality of cutting tips secured to each of said tooth supports, said plurality of cutting tips formed of a second material;
said plurality of cutting tips including a first set of cutting tips, said first set of cutting tips having a dimension with a first extent;
said plurality of cutting tips including a second set of cutting tips, said second set of cutting tips having said dimension with a second extent different than the first extent; and
cutting tips of the first set of cutting tips alternating with cutting tips of the second set of cutting tips.

17. The saw blade of claim 15, wherein the first extent is defined by a first grinding operation and the second extent is defined by a second grinding operation.

18. The saw blade of claim 16, wherein the first grinding operation is on the side faces of the first set of cutting tips and the second grinding operation is on the second set of cutting tips.

19. The saw blade of claim 16, wherein the first grinding operation is on the top face of the first set of cutting tips and the second grinding operation is on the second set of cutting tips.

20. The saw blade of claim 16, wherein the first grinding operation is on the leading face of the first set of cutting tips and the second grinding operation is on the second set of cutting tips.

21. A method of making a saw blade comprising:
forming a plurality of tooth supports out of a first material disposed about the periphery of the blade;
securing a cutting tip to each of said tooth supports, said cutting tips formed of a second material;
creating a first set of cutting tips by grinding each cutting tip of said first set of cutting tips after it is secured to said tooth supports to make a dimension with a first extent;
creating a second set of cutting tips by grinding each cutting tip of said second set of cutting tips after it is secured to said tooth supports to make said dimension with a second extent different than the first extent; and
alternating the cutting tips of the first set of cutting tips with the cutting tips of the second set of cutting tips.

22. The method of claim 20, wherein the dimension is the width of the cutting tips and the first extent is created by grinding a leading face of each cutting tip.

23. The method of claim 20, wherein the dimension is the radial extension of the cutting tips and the first extent is created by grinding a leading face of each cutting tip.

24. The method of claim 20, wherein the dimension is the hook angle of the cutting tips and the first extent is created by grinding a leading face of each cutting tip.

25. The method of claim 20, wherein the dimension is the radial extension of the cutting tips and the first extent is created by grinding a top face of each cutting tip.

26. The method of claim 20, wherein the dimension is the width of the cutting tips and the first extent is created by grinding a side face of each cutting tip.
